(19) United States
(12) Patent Application Publication
(10) Pub. No.: US 2022/0135775 A1
(43) Pub. Date: May 5, 2022

(54) PROCESS FOR PREPARING INDIVIDUAL CELLULOSE NANOCRYSTALS, AND CELLULOSE NANOCRYSTALS AND USE THEREOF

(71) Applicant: FRAUNHOFER-GESLLSCHAFT ZUR FÖRDERUNG DER ANGEWANDTEN FORSCHUNG E.V., München (DE)

(72) Inventor: Hatem ABUSHAMMALA, Braunschweig (DE)

(21) Appl. No.: 17/430,513

(22) PCT Filed: Jan. 27, 2020
(86) PCT No.: PCT/EP2020/051880

§ 371 Date: Aug. 12, 2021

(30) Foreign Application Priority Data
Feb. 14, 2019 (DE) 10 2019 103 717.4

(51) Int. Cl. C08L 1/04; C09D 5/24

(52) U.S. Cl. CPC C08L 1/04; B82Y 30/00; C09D 5/24

(57) ABSTRACT

The invention relates to a process for preparing individual cellulose nanocrystals having an electrically conductive coating, said process comprising the steps: reacting non-oxidised glucose units of cellulose with an aryl or heteroaryl compound having an isocyanate group to form a carbamate bond between at least one of the C2, C3 and C6 atoms of the glucose unit and the aryl or heteroaryl compound; polymerising adjacent aryl or heteroaryl compounds bonded to the glucose unit of the cellulose via the carbamate group, such that an electrically conductive structure of these compounds containing aryl or heteroaryl groups is formed.

The invention relates to a process for producing individual cellulose nanocrystals having an electrically conductive coating, to cellulose nanocrystals having an individual electrically conductive coating as such and to the use of cellulose nanocrystals having an electrically conductive coating.

The increasing use of electrical and electronic components is leading to problems in the disposal of the corresponding products or components. So-called E-waste accounts for a large share of resource consumption since the amount of electronic assemblies is ever increasing on account of the ever shorter model and product cycles, thus having a deleterious effect on the environment and/or the climate. Especially the rapid iteration of technological products and the use of nonbiodegradable fossil hydrocarbon-based types of components has an adverse effect. Furthermore, adverse environmental effects may occur on account of the production processes of the electronic assemblies or their components and on account of the recycling of these assemblies and components.

Cellulose nanocrystals as such, used for example as aerogels, hydrogels or organogels, are already known from the prior art. WO 2011/030170 A1 describes cellulose nanocrystals and production processes and uses thereof. The advantage of cellulose is that it is a biodegradable product that is readily available worldwide and renewable. It is estimated that worldwide 100 billion tons of cellulose are produced annually.

US 2016/0148715 A1 describes a composition composed of a cellulose nanocrystal core and a conductive polymer.

Cellulose nanocrystals themselves are easily producible from cellulose and have a rodlike structure. Cellulose nanocrystals exhibit advantageous mechanical stiffness and strength, provide a large surface area and are biodegradable. They may be subjected to a multiplicity of surface modifications and can self-assemble to afford very interesting, liquid-crystalline structures. Cellulose nanocrystals as such are not electrically conductive and have hitherto only been combined to form a carrier material to produce a flexible paper having an electrically conductive coating composed of polymers, such as polyaniline.

It is an object of the present invention to provide a process and a material which is biodegradable and variedly employable for electrical and electronic components.

According to the invention this object is achieved by a process having the features of the main claim, by cellulose nanocrystals having the features of the further independent claim and by the use thereof. Advantageous embodiments and developments of the invention are disclosed in the subsidiary claims, the description and the figures.

The process for producing individual cellulose nanocrystals having an electrically conductive coating provides for reacting nonoxidized glucose units of cellulose with an isocyanate-comprising aryl or heteroaryl compound to form a carbamate bond between at least one of the C2-, C3- and C6-atoms of the glucose unit and the aryl or heteroaryl compound. Subsequently, adjacent aryl or heteroaryl compounds bonded to the glucose units of the cellulose via the carbamate group are polymerized so as to form an electrically conductive structure of these aryl- or heteroaryl-containing compounds. This makes it possible to provide individual nanocrystals with an individual electrically conductive coating and to form these individually electrically conductive cellulose nanocrystals into products or to make them into parts of products. The process thus comprises initially providing cellulose nanocrystals which are bonded with at least one hydroxyl group on the surface of the cellulose nanocrystals to one of two isocyanate groups of a toluene diisocyanate.

The respective other isocyanate group of the toluene diisocyanate is hydrolyzed to afford another amine group and the amine group is subsequently polymerized with a benzene ring of an adjacent toluene diisocyanate.

The aryl or heteroaryl compound may comprise a phenyl group, pyrrole group, naphthalene group, anthracene group and/or phenanthrene group and other groups may optionally also be part of the aryl or heteroaryl compound.

The aryl or heteroaryl compound which comprises an isocyanate group may especially comprise one diisocyanate group or two or more diisocyanate groups. If the aryl or heteroaryl compound comprises one or more diisocyanate groups a hydrolysis of the second isocyanate group is effected after reaction and formation of the carbamate bond.

The polymerization may be a free-radical polymerization and the electrically conductive coating may be a polyaniline-like, intrinsically electrically conductive coating.

The reacting of the nonoxidized glucose units of the cellulose with an isocyanate-comprising aryl or heteroaryl compound preferably affords the carbamate bond between the C6-atom of the glucose unit and the aryl or heteroaryl compound.

The reacting of the isocyanate-comprising aryl or heteroaryl compound with the glucose is carried out in toluene, acetone, dimethyl sulfoxide, tetrahydrofuran, chloromethane or pyridine with a tertiary amine (TEA), for example with trimethylamine.

The cellulose nanocrystals are preferably rod-shaped and have a length between 50 nm and 500 nm and/or a width or a diameter between 3 nm and 20 nm.

The invention likewise relates to individual cellulose nanocrystals having an individual electrically conductive coating, especially obtainable by a process as described hereinabove.

At least some of the cellulose molecules from which a cellulose nanocrystal is formed are bonded to one of the isocyanate groups which preferably derive from the toluene diisocyanate. The hydroxyl group of the cellulose molecule is bonded to one of the two isocyanate groups of a toluene diisocyanate, wherein the other isocyanate group of the toluene diisocyanate is preferably hydrolyzed to afford an amine group. Cellulose molecules and iso-groups are polymerized to afford a cellulose nanocrystal, wherein the amine group is polymerized to afford an electrically conductive coating to form an individually conductive nanocrystal based on cellulose.

It is preferable when cellulose nanocrystals having an electrically conductive coating are employed as biodegradable, electrically conductive components in electrical or electronic assemblies. They may alternatively or in addition be in the form of an aerogel, of printed electrical or electronic circuits, of additively manufactured 3D structures, of sensors, of capacitors, of an electrical fuse, of a battery, of electrically conductive suspensions or dispersions, of surface coatings, of paper, of a coil and/or of a nanocable.

The process described hereinabove makes it possible to arrange aniline monomers on the surface of cellulose nanocrystals and subsequently perform the polymerization. As a result the cellulose nanocrystal produced therefrom becomes individually conductive and can individually function as a so-called nanocable, which are simple to orient, filter and arrange. These features can multiply the fields of use and applications. Both in the form of suspensions or dispersions and nanopapers, cellulose nanocrystals may be used to produce printed circuit boards or conductive 3D structures, thermal sensors and the like.

The invention is hereinbelow more particularly elucidated with reference to the figures:

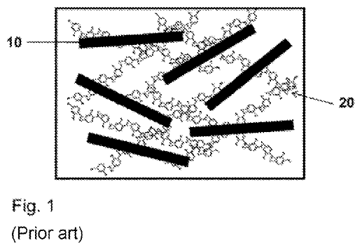

FIG. 1 shows a representation of a mixture of cellulose nanocrystals and polyaniline according to the prior art;

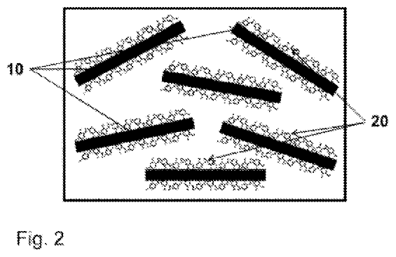

FIG. 2 shows a representation of a cellulose nanocrystal according to the invention and

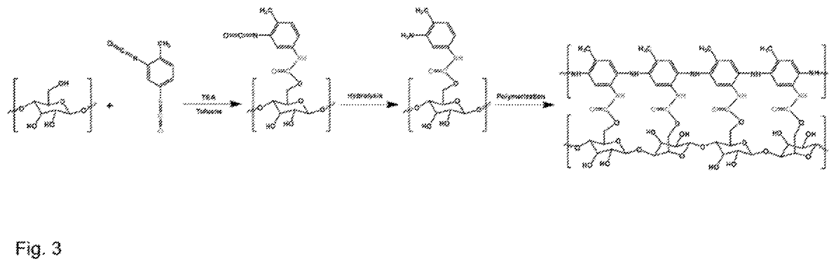

FIG. 3 shows a schematic representation of the production process.

FIG. 1 shows a conventional conductive mixture of cellulose nanocrystals 10 within a matrix of a conductive polymer 20, for example polyaniline. The cellulose nanocrystals 10 are not independently conductive but form the structural material for providing sufficient strength or other mechanical properties.

FIG. 2 shows cellulose nanocrystals 10 according to the invention which are individually provided with a conductive coating 20. The coating 20 is not made of polyaniline but rather utilizes a reaction with toluene diisocyanate to produce an individual coating.

The process is schematically elucidated in FIG. 3. Initially cellulose nanocrystals are provided and a hydroxyl group on the surface of the cellulose nanocrystals 10 is reacted with one of the two isocyanate groups of the toluene diisocyanate. This is followed by a hydrolysis of the other isocyanate group into an amine group. This is followed by polymerization of the amine group with a benzene ring of an adjacent toluene diisocyanate, thus ultimately affording an electrically conductive coating of the cellulose nanocrystal. The electrically conductive coating is intrinsically conductive similarly to a polyaniline coating without employing polyaniline itself.

1. A process for producing individual cellulose nanocrystals having an electrically conductive coating, comprising:
reacting nonoxidized glucose units of cellulose with an isocyanate-comprising aryl or heteroaryl compound of a plurality of isocyanate-comprising aryl or heteroaryl compounds to form a carbamate bond between at least one of the C2-, C3- and C6-atoms of a glucose unit and the aryl or heteroaryl compound;
polymerizing adjacent aryl or heteroaryl compounds of the plurality of isocyanate comprising aryl or heteroaryl compounds which are bonded to the glucose units of the cellulose via the carbamate group such that an electrically conductive coating structure comprising aryl- or heteroaryl-containing compounds is formed.

2. The process for producing individual cellulose nanocrystals having an electrically conductive coating as claimed in claim 1, wherein the aryl or heteroaryl compound is selected from the group consisting of a phenyl group, pyrrole group, naphthalene group, anthracene group, and phenanthrene group.

3. The process for producing individual cellulose nanocrystals having an electrically conductive coating as claimed in claim 1, wherein the isocyanate-comprising aryl or heteroaryl compound comprises diisocyanate groups consisting of first and second isocyanate groups.

4. The process for producing individual cellulose nanocrystals having an electrically conductive coating as claimed in claim 3, further comprising hydrolyzing the second isocyanate group after reaction and formation of the carbamate bond.

5. The process for producing individual cellulose nanocrystals having an electrically conductive coating as claimed in claim 1, wherein the polymerization is a free-radical polymerization.

6. The process for producing individual cellulose nanocrystals having an electrically conductive coating as claimed in claim 1, wherein the electrically conductive coating is a polyaniline-like coating.

7. The process for producing individual cellulose nanocrystals having an electrically conductive coating as claimed in claim 1, wherein the reacting of non-oxidized glucose units of the cellulose reacts at the C6-atom of the glucose unit with the isocyanate-comprising aryl or heteroaryl compound affords to form the carbamate bond.

8. The process for producing individual cellulose nanocrystals having an electrically conductive coating as claimed in claim 1, wherein the reacting of the isocyanate-comprising aryl or heteroaryl compound with the nonoxidized glucose units is carried out in toluene, acetone, dimethyl sulfoxide, tetrahydrofuran, chloromethane or pyridine with a tertiary amine (TEA).

9. An individual cellulose nanocrystal having an electrically conductive coating, wherein said cellulose nanocrystal is rod-shaped and has one or more of a length between 50 nm and 500 nm, and and/or a width or a diameter between 3 nm and 20 nm.

10. The individual cellulose nanocrystal obtained by a process as claimed in claim 1.

11. The cellulose nanocrystal as claimed in claim 10, wherein said cellulose nanocrystal is rod-shaped and has one or more of a length between 50 nm and 500 nm, and a width or a diameter between 3 nm and 20 nm.

12. Cellulose nanocrystals having an electrically conductive coating produced by the process as claimed in claim 1 wherein the cellulose nanocrystals are incorporated into a device or material selected from the group consisting of a biodegradable electrically conductive component, an aerogel, as a printed electrical or electronic circuit, an additively produced 3D structure, a sensor, a capacitor, an electrical fuse, a battery, an electrically conductive dispersion, a surface coating, paper, a coil, and a nanocable.
